(19) United States
(12) Patent Application Publication
(10) Pub. No.: US 2022/0232854 A1
(43) Pub. Date: Jul. 28, 2022

(54) MYCELIATED PROTEIN COMPOSITIONS HAVING IMPROVED TEXTURE AND METHODS FOR MAKING

(71) Applicant: MycoTechnology, Inc., Aurora, CO (US)

(72) Inventors: Marina NADAL, Aurora, CO (US); Michelle J. WILLIAMS, Aurora, CO (US); Delaney A. SMITH, Aurora, CO (US); Alan D. HAHN, Aurora, CO (US); Anthony J. CLARK, Aurora, CO (US); James Patrick LANGAN, Aurora, CO (US); Brooks John KELLY, Aurora, CO (US)

(73) Assignee: MycoTechnology, Inc., Aurora, CO (US)

(21) Appl. No.: 17/608,383

(22) PCT Filed: May 15, 2020
(86) PCT No.: PCT/US2020/033106

§ 371 Date: Nov. 2, 2021

Related U.S. Application Data
(60) Provisional application No. 62/849,080, filed on May 16, 2019.
(60) Provisional application No. 62/887,473, filed on Aug. 15, 2019.

(51) Int. Cl. A23K 10/12; A23J 1/12; A23J 3/14; A23J 3/22; A23K 10/30; A23K 20/147; A23L 31/00; A23L 33/185

(52) U.S. Cl. CPC A23K 10/12; A23J 1/12; A23J 3/14; A23L 33/185; A23K 10/30; A23K 20/147; A23L 31/00; A23J 3/227

(57) ABSTRACT

Provided is a method to prepare a protein food product based on solid state fermentation, which includes the steps of preparing a sterilized substrate comprising a grain such as rice or quinoa and a plant protein concentrate or isolate such as pea protein, inoculating the sterilized substrate with a filamentous fungal culture such as Morchella esculenta culture, and culturing the filamentous fungal culture in the substrate, resulting in a myceliated substrate that has texture more similar to meat and/or improved flavor and aroma when cooked as compared to control substrate (e.g., unmyceliated). Similarity in texture to cooked meat includes increased spring and cohesiveness on chewing, and also where the protein food product, and the improved flavor includes increased savory and umami and decreased bitterness and improved aroma includes decreased pea or beany aroma. Also provided are protein food products made by the methods provided and food compositions, for example, meat analog products, made using the methods and compositions provided.

### CROSS-REFERENCE TO RELATED APPLICATIONS

This application claims the benefit of priority to U.S. Provisional Patent Application No. 62/849,080, filed May 16, 2019 and U.S. Provisional Patent Application No. 62/887,473, filed Aug. 15, 2019, each of which are specifically incorporated by reference in their entireties to the extent not inconsistent herewith.

### BACKGROUND OF INVENTION

There is a growing need for efficient, high quality and low-cost high-protein food sources with acceptable taste, flavor and/or aroma profiles. However, it has proven difficult to achieve such products, particularly with low cost vegetarian protein sources.

Currently, meat extenders and analogs can be made from textured vegetable proteins, such as soy protein isolates and concentrates, processed using an extruder in the shape of rods or tubes. Textured soy protein isolate, also called textured vegetable protein, is usually made from high (50%) soy protein, soy flour or concentrate, but can also be made from other vegetable materials, such as cotton seeds, wheat, and oats. It is extruded into various shapes (chunks, flakes, nuggets, grains, and strips) and sizes, exiting the nozzle while still hot and expanding as it does so. The thermoplastic proteins are heated to 150-200° C., which denatures them into a fibrous, insoluble, porous network that can soak up as much as three times its weight in liquids. As the pressurized molten protein mixture exits the extruder, the sudden drop in pressure causes rapid expansion into a puffy solid that is then dried. As much as 50% protein when dry, textured soy protein can be rehydrated at a 2:1 ratio, which drops the percentage of protein to an approximation of ground meat at 16%.

It is challenging to create a plant-based meat that resembles animal meat and possesses meat-like attributes when cooked (e.g., meat-like color, aroma, taste, chewiness, cohesiveness, texture), without a texturization step. Thus, production processes for many currently available meat-like food products are cumbersome, time-consuming, and costly. Instead, the available products have looser and less complex protein structures that, even upon cooking, disassemble easily during chewing, requiring an unsatisfactory, diminutive bite force and chewing time, and imparting sensations of “pastiness”, and lack of cohesion and/or spring upon bite and chew-down.

It would be useful to have improved plant-based meat substitutes, which better replicate the cohesiveness, spring, texture, aromas and flavors of meat during and/or after cooking.

Tempeh is a traditional Southeast Asian soy product. It is made by a natural culturing and controlled fermentation process that binds whole soybeans into a cake form, using Rhizopus oligosporus. Like tofu, tempeh is made from soybeans, but it is a whole soybean product with different nutritional characteristics and textural qualities. Tempeh's fermentation process and its retention of the whole bean give it a higher content of protein, dietary fiber, and vitamins. It has a firm texture and an earthy flavor, which becomes more pronounced as it ages.

It would be desirable to achieve an efficient, high quality and low cost protein product, such as a meat analog, with meat-like texture, taste, flavor and/or aroma profiles, and for processes for creating improved vegetarian and vegan products, without the need for further processing, e.g., the process of extrusion to improve the texture of the material. Optimally, the meat analog would have a proximate analysis for protein that is similar to meat.

### SUMMARY OF THE INVENTION

The method includes a step to prepare a protein food product for human or animal consumption, comprising the steps of providing a sterilized substrate comprising a grain and a plant protein concentrate or isolate, wherein the substrate is at least 50% protein isolate or concentrate by dry weight, and inoculating the sterilized substrate with a filamentous fungal culture in solid state fermentation conditions; and culturing the filamentous fungal culture and the sterilized substrate, wherein the filamentous fungal culture grows hyphae and forms a mycelial network to form protein food product. In embodiments, the protein food product, after cooking, is (i) more cohesive than a non-myceliated control substrate after cooking, and/or (ii) has more spring than a non-myceliated control substrate after cooking, and/or (iii) has more juiciness than a non-myceliated control substrate after cooking; and additionally, wherein the protein food product has increased desirable flavors and/or reduced undesirable aromas and/or flavors compared to a non-myceliated control substrate.

In embodiments, the method further includes treating the myceliated meat analog to inactivate the filamentous fungus. The moisture content of the sterilized substrate can be at least about 1.5 ml per g of dry weight substrate. The filamentous fungal culture comprises or is selected from the group consisting of Morchella spp Lentinula spp., or Pleurotus spp.; in one embodiment, the filamentous fungal culture comprises or consists of Morchella esculenta. In one embodiment, the plant protein concentrate or isolate comprises pea protein concentrate and wherein the grain is rice, quinoa, chickpea or combinations thereof and the increased desirable flavor is an umami flavor and the reduced undesirable aroma is a pea aroma. In one embodiment, the sterilized substrate comprises 70 to 80% protein concentrate or isolate by dry weight and about 20 to 30% grain by dry weight. In embodiments, the method further includes forming the sterilized substrate into a predetermined shape.

The present invention includes a protein food product made by the methods of the invention. The compositions of the invention include a protein food product comprising a myceliated substrate for human or animal consumption. The protein food product can be used in various foods, including a meat analog.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

The present invention includes culturing a filamentous fungus in a solid-state culture using a substrate that contains at least one grain and at least one plant protein, to provide a composition comprising a protein food product having a proximate analysis for protein which is similar to meat. Unexpectedly, the inventors found that such treatment can alter the taste, flavor or aroma of these compositions in unexpected ways to provide savory and umami flavors to the substrate material, and also the treatment unexpectedly provides a cooked texture similar to that of cooked texturized plant protein “meat” or actual meat without further additional processing such as mechanical texturization. The process uses a combination of at least one grain and at least one protein isolate or concentrate to achieve a protein content similar to that of meat, followed by a myceliation process to remove undesirable tastes and aromas, and/or add desirable tastes and aromas, and/or provide texture (when cooked) to be more similar to cooked ground meat or texturized plant protein. The myceliation causes growth of hyphae to form a mycelial network to allow the composition to optionally be more cohesive, and/or have greater spring, and/or have increased juiciness, and/or have decreased tooth pack compared to an unmyceliated control composition.

Therefore, in one embodiment, the present invention includes a method to prepare a protein food product for human and/or animal consumption. The method may include a step of providing a sterilized substrate comprising at least one grain and at least one protein concentrate or isolate, wherein the substrate is at least 50% protein isolate or protein concentrate by dry weight. In one embodiment, the protein isolate or protein concentrate is in powder or non-texturized form. In one embodiment, a proximate analysis of the protein food product substrate shows that the substrate is similar in composition to meat, in particular, similar in the percentage of protein per a proximate analysis, for example. The method may also include a step of inoculating the sterilized substrate with a filamentous fungal culture. The method may also include the step of culturing the filamentous fungal culture and the sterilized substrate, wherein the filamentous fungal culture grows hyphae and forms a mycelial network to form a myceliated substrate, wherein the myceliated substrate has improved texture relative to a non-myceliated control substrate, and wherein the myceliated substrate has reduced undesirable flavors and reduced undesirable aromas compared to a non-myceliated control substrate, wherein the protein food product comprises the myceliated substrate. In an embodiment, the protein food product, after cooking, is (i) more cohesive than a non-myceliated control substrate after cooking, and/or (ii) has more spring than a non-myceliated control substrate after cooking, and/or (iii) has more juiciness than a non-myceliated control substrate after cooking. In an embodiment, the protein food product has increased desirable flavors and/or reduced undesirable aromas compared to a non-myceliated control substrate.

The processes of the invention enable the production of food compositions, protein concentrates, isolates and high protein foodstuffs that have been imbued with mycelial material, thereby altering aspects of the substrate used in the production of products according to the methods of the present invention. The invention also presents the ability to stack protein sources to optimize amino acid profiles of products made according to the methods of the invention.

The substrate may comprise, consist of, or consist essentially of a protein concentrate or isolate material together with at least one grain material. Typically, a protein concentrate is made by removing the oil and most of the soluble sugars from a meal, such as soybean meal. For example, pea protein, in embodiments, is made by grinding dried peas into a fine powder. The starch and fiber are removed, leaving a powdered concentrated protein substance (aka pea protein concentrate or isolate). Such a protein concentrate may still contain a significant portion of non-protein material, such as fiber. Typically, protein concentrations in such products are between 55-90%. The process for production of a protein isolate typically removes most of the non-protein material such as fiber and may contain up to about 90-99% protein. A typical protein isolate is typically subsequently dried and is available in a powdered form and may alternatively be called “protein powder.” In an embodiment, the protein isolate or concentrate useful for the invention is a protein concentrate or powder in the absence of further processing. For example, the protein concentrate or isolate is in the form of the powdered protein extract, for example, without further mechanical processing such as mechanical texturization or mechanical extrusion.

The protein concentrate or isolate to include in the substrate can be obtained from a number of sources, including vegetarian sources (e.g., plant sources) as well as non-vegetarian sources, and can include a protein concentrate and/or isolate. Vegetarian sources include meal, protein concentrates and isolates prepared from a vegetarian source such as pea, oats, rice, soy, cyanobacteria, grain, hemp, chia, quinoa, chickpea, potato protein, corn, wheat, other grains, legumes, cereals, algal protein and nettle protein or combinations of these. In embodiments, the vegetarian source is pea, rice, chickpea or a combination thereof. In embodiments, the vegetarian source is pea, chickpea or a combination thereof. In embodiments, the vegetarian source is quinoa, pea, or a combination thereof. Certain vegetable sources have disadvantages as well, while soy protein isolates have good Protein Digestibility Corrected Amino Acid Scores (PDCAAS) and digestible indispensable amino acid scores (DIAAS), and is inexpensive, soy may be allergenic and has some consumer resistance due to concerns over phytoestrogens and taste. Rice protein is highly digestible but is deficient in some amino acids such as lysine. Rice protein is therefore not a complete protein and further many people perceive rice protein to have an off-putting taste and aroma. Pea protein is generally considered to contain all essential amino acids, is not balanced and thus is not complete and many people perceive pea protein to have an off-putting aroma of pea aroma, beany aroma, and may have bitter notes in flavor. Hemp protein is a complete protein. Non-vegetarian sources for the meat analog material may also be used in the present invention. Such non-vegetarian sources include whey, casein, egg, meat (beef, chicken, pork sources, for example), isolates, concentrates, broths, or powders.

In one embodiment, the protein material is a myceliated high protein material as disclosed in e.g., U.S. Pat. No. 10,010,103, filed Apr. 14, 2017, U.S. Ser. No. 16/025,365, (filed Jul. 2, 2018), both entitled “Methods for the Production and use of Myceliated High Protein Food Compositions,”, U.S. Ser. No. 62/752,158 (filed Oct. 29, 2018), U.S. Ser. No. 62/796,438 (filed Jan. 24, 2019), related to aqueous-phase fermentation of protein materials, all of which are incorporated by reference herein in their entireties, the disclosure of each of which is hereby incorporated by reference herein in its entirety.

In one embodiment, mixtures of any of the protein concentrate or isolate materials disclosed can be used to provide, for example, favorable qualities, such as a more complete (in terms of amino acid composition) protein concentrate or isolate material. In one embodiment, materials such as pea protein and rice protein can be combined.

The plant protein isolate or concentrate itself can be about 20% protein, 30% protein, 40% protein, 45% protein, 50% protein, 55% protein, 60% protein, 65% protein, 70% protein, 75% protein, 80% protein, 85% protein, 90% protein, 95% protein, or 98% protein, or at least about 20% protein, at least about 30% protein, at least about 40% protein, at least about 45% protein, at least about 50% protein, at least about 55% protein, at least about 60% protein, at least about 65% protein, at least about 70% protein, at least about 75% protein, at least about 80% protein, at least about 85% protein, at least about 90% protein, at least about 95% protein, or at least about 98% protein. In embodiments, the plant protein concentrate or isolate is at least about 65% protein or at least about 70% protein.

This invention discloses the use of a mixture of a grain-based substrate and a high protein substrate as the basis for a stationary, solid phase myceliation to allow the filamentous fungus to form hyphae which can form mycelial networks. This provides the basis, for example, an economically viable economic process for production of an acceptably tasting and/or flavored meat analog food product that does not require an extrusion-type step to form an acceptable meat-like texture upon cooking.

The substrate also comprises a grain-based substrate or material. The grain material can comprise, consist of, or consist essentially of one or more of the following, or combinations thereof: barley, rice, such as brown rice, white rice, short grain rice, long grain rice, wild rice, buckwheat, bulgur (cracked wheat), flaxseed, grano, millet, oats, oat bread, oat cereal, oatmeal, popcorn, whole wheat cereal flakes, muesli, rolled oats, quinoa, rye, sorghum, spelt, triticale, whole grain barley, chickpea, wheat berries, whole grain cornmeal, whole rye, whole wheat bread, whole wheat couscous, and the like. The grain may be in a processed or partially processed form, such as flour (milled) or in whole form. Preferably, the grain is used in dried form.

In one example of an embodiment of the invention, the dry weight of the protein concentrate or isolate as a proportion of the substrate is at least 30% dry weight, at least 35% dry weight, at least 40% dry weight, at least 45% dry weight, at least 50% dry weight, at least 55% dry weight, at least 60% dry weight, at least 65% dry weight, at least 70% dry weight, at least 75% dry weight, at least 80% dry weight, at least 85% dry weight, at least 90% dry weight, or at least 95% dry weight. In another example of an embodiment, the dry weight of the grain material can be at least 5% by dry weight, at least 10% by dry weight, at least 15% by dry weight, at least 20% by dry weight, at least 25% by dry weight, at least 30% by dry weight, at least 35% by dry weight, at least 40% by dry weight, at least 45% by dry weight, at least 50% by dry weight, at least 55% by dry weight, at least 60% by dry weight, at least 65% by dry weight, or at least 70% by dry weight. In embodiments, the protein concentrate or isolate is approximately at least 65%, at least 70%, or at least 75% by dry weight of the substrate. If the grain is not in dried form, the amounts can be adjusted for wet weight as known in the art.

The dry substrate is optionally wetted prior to inoculating the substrate. The wetting should be with sufficient moisture to allow mycelia to grow. In one embodiment, the wetting agent is water, although wetting agents can optionally include excipients such as salts or nutrients. In embodiments, the dry ingredients have wetting agent added in a ratio of about 1 g weight substrate, to between about 1.5 and 2.0 ml wetting agent. In other words, for each g of substrate, optionally, between about 1.5 ml and 2 ml of wetting agent are added. This ratio can be adjusted in order to optimize growth of the fungus and myceliation of the substrate.

In an embodiment, the substrate may have approximately 24% grain by dry weight and approximately 76% protein concentrate or isolate by dry weight. In one embodiment, it is important that the substrate have added moisture of at least 150% w/v (weight substrate to volume wetting agent) to allow growth of mycelia; in embodiments, the dry ingredients is at about 178% w/v of water. Lower proportions of water in the substrate (e.g., 100% w/v) may result in a mixture that does not allow for any mycelial growth during the culturing phase. If no growth occurs during the culturing step, then the filamentous fungus cannot form hyphae which are able to form the mycelial network to provide the desired greater cohesiveness of the substrate following culturing.

In an embodiment, therefore, the texture of the prepared protein food product of the present invention is like that of cooked ground meat and/or texturized plant protein, having been improved by the process of myceliation. For example, the texture of meats such as ground beef or meat crumbles are imitated by mechanically texturized protein. The present invention provides for similar texture as a mechanically texturized protein without the mechanical texturization step.

Texturized plant proteins (cooked) and cooked ground meat have texture properties that can be understood as “spring”, including “spring on chew-down”; and “cohesiveness,” including “cohesiveness of mass.” They also have “juiciness” which can be understood as free liquid (water, liquid fat, or combination thereof) leaving a mass during bite-down, but where the mass still retains its cohesiveness to some degree (e.g., the experience of bite-down is not a wet or mushy experience). For example, cooked texturized proteins/cooked ground meat have “spring” upon first bite, where upon first chew the material springs back partially instead of remaining deformed like a paste; and also they have spring during “chew-down” where springiness continues to be experienced until fully masticated. An example of a high “spring” food is a marshmallow. In a cooked ground-meat patty/texturized protein, such texture is experienced as an initial moderate springiness with low to moderate springiness upon chew-down. Another parameter of texture is the cohesiveness and cohesiveness of the mass. Cohesiveness is the experience of whether the mass stays together or how much it crumbles; the cohesiveness of the mass is how well the mass forms a bolus upon chewing. An example of a high cohesiveness food is chewing gum, where the there is no crumbling. Ground-meat patties cooked have low to moderate cohesiveness and cohesiveness of mass. Hardness is another parameter that relates to the degree of force that is required to bite through the product. Ground-meat products cooked have a low hardness. Finally, “tooth pack” refers to whether the material sticks to the molars of the teeth upon chewing; cooked ground-meat patty has a low tooth pack. Tooth stick refers to whether the food causes the teeth to stick together; cooked ground meat has a low tooth stick. In an embodiment, the cooked protein food product has a low to moderate spring, a low to moderate cohesiveness and cohesiveness of mass, a low to moderate hardness, and low tooth pack and tooth stick. In an embodiment, the texture of the cooked protein food product of the present invention, is similar to a cooked texturized soy protein and/or to a cooked ground beef patty.

Typically, addition of a protein concentrate or isolate to the substrate, in the amounts taught herein, especially after wetting as directed herein, results in a mixture with a “pasty” type of consistency, having no spring, no cohesiveness, and no juiciness, even after cooking. Such consistency is described similar to that of a mushy material with solid pieces (due to presence of whole grains such as rice, quinoa, etc.) When the substrates described in the invention are put through a “sham” fermentation type process, tasters found that a sham fermentation substrate, after undergoing the processing steps of the invention, and a cooking step, but with an inoculation that does not include mycelia, still behaves as a paste while chewing (i.e., having no spring, no cohesiveness, no juiciness). Accordingly, the invention's improvement in texture is due to the myceliation process.

On the other hand, after being subjected to the processes of the invention, the myceliated material, after a cooking step, provides a “cooked meat-like food product” which, as used herein refers to a food product that is not derived from an animal but has structure, texture, and/or other properties comparable to those of cooked animal meat and/or similar to a cooked texturized plant protein, such as soy and/or pea protein, as described hereinabove.

Therefore, in embodiments, a cooked prepared protein food product has a low to moderate cohesiveness and/or a low to moderate cohesiveness of mass; and/or a low to moderate spring; and/or low to moderate juiciness; and/or low hardness; and/or a low to moderate tooth pack and/or tooth stick. In an embodiment, the cooked protein food product has a low to moderate spring, a low to moderate cohesiveness and cohesiveness of mass, a low to moderate hardness, and low tooth pack and tooth stick. In an embodiment, the texture of the cooked protein food product of the present invention is similar to a cooked texturized soy protein and/or to a cooked ground beef patty. In embodiments, the cooked protein food product of the present invention has one or more improved cohesiveness, improved cohesiveness of mass, improved spring, improved juiciness, improved tooth pack, and improved tooth stick over a cooked food product having been treated via sham fermentation.

In another embodiment, the prepared protein food product of the present invention has a proximate analysis wherein the amount of protein present is similar to that of meat. For example, in a 20 g serving size of the present invention, as cooked, the amount of protein is approximately 5.96 g per serving size, or about 0.3 g protein per gram (wet weight). Most meats are in the range of about 0.3 g per gram. In embodiments, then, the present invention has an amount of protein that is between about 0.2 g and 0.4 g protein per gram of prepared protein food product, between about 0.25 g and 0.35 g protein per gram prepared protein food product, or about 0.3 g protein per gram prepared protein food product (wet weight).

In some embodiments, the protein concentrate or isolate material, after preparing the substrate of the invention, is not completely dissolved in the substrate. Instead, the protein material may be partially dissolved, and/or partially suspended, and/or partially colloidal. However, even in the absence of complete dissolution of the protein material, positive changes may be affected during culturing of the protein material.

The inventors have found experimentally that while mycelia grows well on substrates comprising a high percentage of grains, partially replacing the grain with protein concentrates or isolates to a percentage that is similar to meat will cause difficulty with myceliation, causing growth arrest or retardation of the filamentous fungus, unless the amount of moisture (added wetting agent) in the substrate is present at least about 1.5 ml per g of dry weight substrate.

In one embodiment, the substrate further optionally comprises, consists of, or consists essentially of additional excipients as defined herein. The excipients may include “carry-over” from the inoculum when it is used to inoculate the substrate. Excipients can comprise any other components known in the art to potentiate and/or support fungal growth, and can include, for example, nutrients, such as proteins/peptides, amino acids as known in the art and extracts, such as malt extracts, meat broths, peptones, yeast extracts and the like; energy sources known in the art, such as carbohydrates; essential metals and minerals as known in the art, which includes, for example, calcium, magnesium, iron, trace metals, phosphates, sulphates; buffering agents as known in the art, such as phosphates, acetates, and optionally pH indicators (phenol red, for example). Excipients may include carbohydrates and/or sources of carbohydrates added to substrate at 5-10 g/L. Excipients may also include peptones/proteins/peptides/amino acids, as is known in the art. These are usually added as a mixture of protein hydrolysate (peptone) and meat infusion, however, as used in the art, these ingredients are typically included at levels that result in much lower levels of protein in the substrate than is disclosed herein.

In one embodiment, excipients include for example, yeast extract, malt extract, maltodextrin, peptones, and salts such as diammonium phosphate and magnesium sulfate, as well as other defined and undefined components such as potato or carrot powder. In some embodiments, organic (as determined according to the specification put forth by the National Organic Program as penned by the USDA) forms of these components may be used.

In one embodiment, excipients comprise, consist of, or consist essentially of dry carrot powder, dry malt extract, diammonium phosphate, magnesium sulfate, and citric acid.

The method comprises sterilizing the substrate prior to inoculation by methods known in the art, including steam sterilization and all other known methods to allow for sterile procedure to be followed throughout the inoculation and culturing steps to enable culturing and myceliation by pure fungal strains. Alternatively, the components of the substrate may be separately sterilized, and the substrate may be prepared according to sterile procedure.

The method also includes inoculating the substrate with a fungal culture. The fungal culture may be prepared by culturing by any methods known in the art. In one embodiment, the methods to culture may be found in, e.g., PCT/US14/29989, filed Mar. 15, 2014, PCT/US14/29998, filed Mar. 15, 2014, all of which are incorporated by reference herein in their entireties.

The fungal cultures, prior to the inoculation step, may be propagated and maintained as is known in the art. In one embodiment, the fungi discussed herein can be kept on yeast extract/dextrose agar.

In one embodiment, maintaining and propagating fungi for use for inoculating the substrate material as disclosed in the present invention may be carried out as follows. For example, a propagation scheme that can be used to continuously produce material according to the methods is discussed herein. Once inoculated with master culture and subsequently colonized, Petri plate cultures can be used at any point to propagate mycelium into prepared liquid media.

In some embodiments, liquid cultures used to maintain and propagate fungi for use for inoculating the substrates as disclosed in the present invention include undefined agricultural media with optional supplements as a motif to prepare culture for the purposes of inoculating solid-state material or larger volumes of liquid. In some embodiments, liquid media preparations are made as disclosed herein. Liquid media can be also sterilized and cooled similarly to agar media. As such, liquid media are typically inoculated with agar, liquid and other forms of culture. Bioreactors provide the ability to monitor and control aeration, foam, temperature, and pH and other parameters of the culture and as such enables shorter myceliation times and the opportunity to make more concentrated media.

In one embodiment, the fungi for use for inoculating the substrate material as disclosed in the present invention may be prepared as a submerged liquid culture and agitated on a shaker table, or prepared as stationary culture, or may be prepared in a shaker flask, in a bioreactor, or a fermenter, or by methods known in the art and according to media recipes known in the art and/or disclosed herein. The fungal component for use in inoculating the aqueous media of the present invention may be made by any method known in the art. In one embodiment, the fungal component may be prepared from a glycerol stock, by a simple propagation motif of Petri plate culture to 0.5 to 4 L Erlenmeyer shake flask to 50% glycerol stock. Petri plates can comprise agar in 10 to 35 g/L in addition to various media components. Conducted in sterile operation, chosen Petri plates can be propagated into 0.5 to 4 L Erlenmeyer flasks (or 250 to 1,000 mL Wheaton jars, or any suitable glassware) for incubation on a shaker table or stationary incubation. In one embodiment, for example, with Morchella esculenta, a dextrose 15 g/L and yeast extract (6.5 g/L) media is prepared and inoculated from a fully grown agar plate and left stationary at 26° C. for one to four weeks.

In another embodiment, a 4 L Erlenmeyer flask prepared as described above is gently blended, then 1 L is transferred into a 7 L fermenter into a media made up of dextrose 15 g/L, yeast extract 6.5 g/L, and anti-foam 0.5 g/L under standard airflow, pressures, and agitation. Growth is allowed to occur for at least 96 hours, with harvest occurring when the change in pH is a drop of at least 0.5 pH. A microscope check was done to ensure the presence of mycelium (mycelial pellets were visible by the naked eye) and the culture was plated on LB media to ascertain the extent of any bacterial contamination and none was observed.

To prepare a homogenous inoculum, in one embodiment, the grown biomass may be mechanically homogenized or homogenized by methods known in the art, using techniques designed to minimize stress or disruption to the cells while yielding a more uniform inoculum. For example, the inoculum may be blended at low speed just until the inoculum can be drawn into a pipette or is “pipette-able.”

Growth media for the inoculum may be any known in the art and includes any components known in the art to potentiate and/or support fungal growth, and can include, for example, nutrients, such as proteins/peptides, amino acids as known in the art and extracts, such as malt extracts, meat broths, peptones, yeast extracts and the like; energy sources known in the art, such as carbohydrates; essential metals and minerals as known in the art, which includes, for example, calcium, magnesium, iron, trace metals, phosphates, sulphates; buffering agents as known in the art, such as phosphates, acetates, and optionally pH indicators (phenol red, for example). In one embodiment, nutrients include for example, yeast extract, malt extract, maltodextrin, peptones, and salts such as diammonium phosphate and magnesium sulfate, as well as other defined and undefined components such as potato or carrot powder.

The culturing step of the present invention may be performed by methods (such as sterile procedure) known in the art and disclosed herein and may be carried out in a sealed bag, bioreactor, tray, or other methods known in the art to permit development of hyphae and a mycelial network while maintaining sterility. In one embodiment, this process consists of depositing a solid culture substrate, as disclosed herein, on flatbeds after seeding it with microorganisms; the substrate is then left in a temperature-controlled room for several days. Inoculation of the sterilized substrate by the inoculum may be carried out by any methods known in the art, including injection into the substrate, spraying or pipetting inoculum onto the surface of the substrate, without limitation.

As is known in the art, in one embodiment, solid state fermentation uses culture substrates with low water levels (reduced water activity). The medium can be saturated with water but little of it is free-flowing. The solid medium comprises both the substrate and the solid support on which the fermentation takes place. incubating the inoculated mixture at a temperature supporting optimum growth of the filamentous fungus in an atmosphere sufficiently humid to support growth until at least some of the spaces between the particles in the mixture are at least partially filled with mycelia of the fungus and the particles are at least partially knitted or bound together by said mycelia. The methods of the present invention further optionally comprise a method of heat treatment such as pasteurizing and/or sterilizing the substrate. In one embodiment, the substrate is sterilized to provide prepared substrate. This step may be accomplished by any method known in the art. For example, this step may be performed under atmospheric pressure or under increased pressure. This step may also be referred to as “pre-processing.” This step is performed to reduce or remove undesirable microbial or fungal organism contaminants on the substrate, particularly mold spores.

The method optionally includes sterilizing the substrate prior to inoculation by methods known in the art, including steam sterilization and all other known methods to allow for sterile procedure to be followed throughout the inoculation and culturing steps to enable culturing and myceliation by pure fungal strains. Alternatively, the components of the substrate may be separately sterilized, and the substrate may be prepared according to sterile procedure.

Sterilization of the substrate may be performed as is known in the art. For example, substrate may be sterilized by heating under pressure at 15 lb/in² at 121-122° C. for 20 to 100 minutes, such as 90 minutes, and adding ¾ lb for every 1,000 ft above sea level. In another embodiment, the steam is superheated to 251-255° F. In one embodiment, substrate is sterilized for 80 minutes at 22 psi with slightly dry saturated steam at 255° F.

Substrate may be sterilized in a container. The container may optionally be the same container as the container used for the aqueous extraction and/or hydration step. The container may be optionally sealed and the substrate may be sterilized by the application of heat to the exterior of the container. In one embodiment, the heat is provided by applying steam to the exterior of the container for a sufficient period of time to allow for sterilization of the contents. In an embodiment, the container is an autoclave bag. A heat transfer model can be developed by methods known in the art to predict required sterilization time based on autoclave temperature and bag thickness.

Suitable containers include containers known in the art for mushroom cultivation. Optionally the containers have a section for exchanging air or gases but do not allow passage of any other component. Such sections are known in the art and include filter strips. In one embodiment, the container is a drum, for example, a 55 gallon drum. In some embodiments, the containers of the instant invention can be glass, carbon and stainless steel drums, carboys, or polypropylene bags or drums. Fermenters and bioreactors can also be used as containers of the instant invention. In some embodiments, the containers have a means for gas exchange that precludes passage of contaminants, such as filter zones or valves. In one embodiment the container is a bag, for example, an autoclavable, polypropylene bag with filter strips.

A further advantage of the bags described above is that when sealed, they conform to shape of the substrate when pressurized during the sterilization step. The bags can be of any dimension. In one embodiment, bags are elongated or flattened to hasten the heating process, for example, the length may be three times the diameter of the bag. This dimension may also facilitate the advantageous stacking of bags or positioning of bags for sterilization.

The size of the bags to be used can be chosen according to the volume or amount of substrate to treat by the methods of the present invention. In another embodiment, the bags are flattened, having a thickness of 1/10th or less than the sum of the peripheral edges of each bag. The bags can be round in shape, having a circumference that defines the peripheral edges of each bag. Alternatively, the bags can be rectangular so that the sum of the sides defines the peripheral edges of each bag. The bags can be conjoined so that a series of rectangular bags can be easily handled in a production environment. All bags have breathable patches (filter strips) that provide for an aerobic environment. In another embodiment, the substrate is vacuum packed in the bags to eliminate air that could draw volatile flavor or aromatic components from the bags.

The method may be carried out in a batchwise manner by placing the substrate and inoculum in a form so that the finished myceliated substrate takes on the shape of the form. Alternatively, the method may be performed in a continuous manner, e.g., in a bioreactor, to form an endless length of composite material.

The invention, in an embodiment, also provides a protein food product, whose final shape is influenced by the enclosure, or series of enclosures, that the growth occurs within and/or around. The protein food product is, in an embodiment, a cohesive and/or self-supporting composite material comprised of a substrate of grain and a protein concentrate or isolate, and a network of interconnected mycelia cells extending through and around the grains and bonding the grains together, and providing the protein content of meat. In one embodiment, the cohesiveness of the myceliated substrate allows the myceliated substrate to be self-supporting and capable of forming or retaining a net shape. For example, in some embodiments, the methods of the present invention include a step of forming the substrate or sterilized substrate into a predetermined shape or net shape. In that embodiment, the filamentous fungus can be inoculated in such a way as to seed growth throughout at least a portion of the substrate. For example, inoculation can take place by injecting inoculum throughout the substrate or at least a portion of the substrate. The inoculated substrate is then allowed to culture until the desired level of myceliation has been achieved, without further mixing. Alternatively, the inoculated substrate, after inoculation, can be placed into and grown in a cavity of a certain geometry, in some embodiments, the myceliated substrate can retain that geometry and/or take on a net shape in accordance with the shape of the cavity.

In one embodiment, inoculated substrate (containing both substrate and inoculum) in bags are treated during culturing o allow for more homogenous myceliation to take place. For example, the mixture may be gently mixed, tumbled, or manipulated periodically, for example, every few hours to every few days, to facilitate even distribution of mycelia and more homogenous myceliation.

It was found that not all fungi are capable of growing in substrate as described herein. Fungi useful for the present invention are from the higher order Basidiomycetes and Ascomycetes. In some embodiments, fungi effective for use in the present invention include, but are not limited to, Lentinula spp., such as L. edodes (shiitake), Pleurotus (oyster) species such as Pleurotus ostreatus, Pleurotus salmoneostramineus (Pleurotus djamor), Pleurotus eryngii, or Pleurotus citrinopileatus; and Morchella spp. (morel). Morchella spp. can include, without limitation, all species of genus Morchella. Morchella is speculated to contain three major evolutionary groups, or “clades.” The first contains Morchella rufobrunnea only and is therefore labeled the rufobrunnea clade; the second, the esculenta clade, contains 5 species in North America; the final clade, the elata clade, contains 14 North American representatives.

In a particular embodiment, the Morchella spp. consists of, consists essentially of, or comprises Morchella esculenta. The present inventors found that M. esculenta provides a combination of meat-like texture (like ground beef) together with a savory and umami taste with a minimum of mold/fungal flavors while deflavoring the pea protein. The composition of the substrate comprised a high level of pea protein in order to provide a protein food product with a protein composition similar to that of ground meat of about 25% to 30% (or, about 27%).

In embodiments, additional Morchella species suitable for the invention can optionally include Morchella angusticeps, Morchella importuna, Morchella americana, Morchella castaneae, Morchella diminutiva Morchella dunensis, Morchella Morchella galilaea, Morchella palazonii, Morchella prava, Morchella sceptriformis, Morchella steppicola, Morchella ulmaria, Morchella vulgaris, Morchella angusticeps, Morchella arbutiphila, Morchella australiana, Morchella brunnea, Morchella conifericola, Morchella deliciosa, Morchella disparilis, Morchella dunalii, Morchella elata, Morchella eohespera, Morchella eximia, Morchella eximioides, Morchella exuberans, Morchella feekensis, Morchella importuna, Morchella kakiicolor, Morchella laurentiana, Morchella magnispora, Morchella mediteterraneensis, Morchella popuhphila, Morchella pukhella, Morchella punctipes, Morchella purpurascens, Morchella semihbera, Morchella septentrionalis, Morchella sextelata, Morchella snyderi, Morchella tomentosa, Morchella tridentina, Morchella anteridiformis, Morchella apicata, Morchella bicostata, Morchella conicopapyracea, Morchella crassipes, Morchella deqinensis, Morchella distans, Morchella guatemalensis, Morchella herediana, Morchella hetieri, Morchella hortensis, Morchella hotsonii, Morchella hungarica, Morchella inamoena, Morchella intermedia, Morchella meiliensis, Morchella miyabeana, Morchella neuwirthii, Morchella norvegiensis, Morchella patagonica, Morchella patula, Morchella pragensis, Morchella procera, Morchella pseudovulgaris, Morchella rielana, Morchella rigida, Morchella rigidoides, Morchella smithiana, Morchella sulcate, Morchella tasmanica, Morchella tatari, Morchella tibetica, Morchella umbrina, Morchella umbrinovelutipes, or Morchella vaporaria.

Fungi may be obtained commercially, for example, from the Penn State Mushroom Culture Collection.

Determining when to end the culturing step and to harvest the myceliated meat analog food product, which according to the present invention, to result in a myceliated meat analog food product with acceptable taste, flavor and/or aroma profiles, can be determined in accordance with any one of a number of factors as defined herein, such as, for example, visual inspection of mycelia, microscope inspection of mycelia, pH changes, changes in dissolved oxygen content, changes in protein content, amount of biomass produced, and/or assessment of taste profile, flavor profile, or aroma profile.

Additionally, mycelial products may be measured as a proxy for mycelial growth, such as, total reducing sugars (usually a 40-95% reduction), ergosterol, β-glucan and/or chitin formation.

Harvest includes obtaining the myceliated meat analog food product which is the result of the myceliation step. After harvest, substrates can be processed according to a variety of methods. In one embodiment, the myceliated substrate is pasteurized or sterilized.

In one embodiment, the myceliated substrate is dried according to methods as known in the art. Additionally, concentrates and isolates of the material may be prepared using variety of solvents or other processing techniques known in the art.

In many cases, the flavor, taste and/or aroma of the substrates, including the individual protein concentrates or isolates and/or grains in the substrates, as disclosed herein, may have flavors, which are often perceived as unpleasant, having pungent aromas and bitter or astringent tastes. These undesirable flavors and tastes are associated with their source(s) and/or their processing, and these flavors or tastes can be difficult or impossible to mask or disguise with other flavoring agents. The present invention, as explained in more detail below, works to modulate these tastes and/or flavors.

Improved flavor of products or compositions of the invention may be measured in a variety of ways, such as the chemical analysis which demonstrate improved tastes such as increased savory tastes and/or mitigated taste defects. Taste tests with taste panels may also be conducted to provide qualitative data with respect to improved taste(s) in the products, with the panels determining whether decreased taste defects have been exhibited in the treated products.

In an embodiment, the compositions of the invention have reduced bitterness and/or reduced bitter or pea flavors or aromas, compared to the compositions of the invention that is not treated by the inventive methods. In some embodiments, the compositions of the invention have increased or improved umami flavors and/or savory flavors, as compared to control “sham” materials. In an embodiment, the compositions of the invention have the changed organoleptic perception as disclosed in the present invention, as determined by human sensory testing. It is to be understood that the methods of the invention only optionally include a step of determining whether the flavors or aromas of the compositions of the invention differs from a control material. The key determinant is, if measured by methods as disclosed herein, that the compositions of the invention are capable of providing the named differences from control materials which have not been combined, mixed or treated as described in the present invention.

Sensory evaluation is a scientific discipline that analyses and measures human responses to the composition of food and drink, e.g. appearance, touch, odor, texture, temperature and taste. Measurements using people as the instruments are sometimes necessary. The food industry had the first need to develop this measurement tool as the sensory characteristics of flavor and texture were obvious attributes that cannot be measured easily by instruments. Selection of an appropriate method to determine the organoleptic qualities, e.g., flavor, of the instant invention can be determined by one of skill in the art, and includes, e.g., discrimination tests or difference tests, designed to measure the likelihood that two products are perceptibly different. Responses from the evaluators are tallied for correctness, and statistically analyzed to see if there are more correct than would be expected due to chance alone.

In the instant invention, it should be understood that there are any number of ways one of skill in the art could measure the sensory differences.

In an embodiment, the compositions of the invention, e.g., produced by methods of the invention, have reduced pea flavor, reduced grassiness, reduced bitterness, or increased savory taste, umami taste, as measured by sensory testing as known in the art. Such methods include change in taste threshold, change in intensity, and the like. At least 10% or more change (e.g., reduction in) is preferred. The increase in desirable flavors and/or tastes may be rated as an increase of 1 or more out of a scale of 5 (1 being no taste, 5 being a very strong taste.) Or, a reference may be defined as 5 on a 9 point scale, with reduced at least one flavor or taste as 1-4 and increased flavor or taste as 6-9. The invention includes reduction in one or more of the named organoleptic qualities (bitter tastes, grassy tastes, pea tastes and/or other undesirable flavors) as discussed herein.

Additionally, the organoleptic qualities of the compositions of the invention may also be improved by processes of the current invention. For example, deflavoring can be achieved, resulting in a milder flavor and/or with the reduction of, for example, bitter and/or pea and/or grassy tastes and/or other flavors. The decrease in undesirable flavors and/or tastes as disclosed herein may be rated as a decrease of 1 or more out of a scale of 5 (1 being no taste, 5 being a very strong taste.) Increased savory flavor can include increased umami flavors, meaty flavors, buttery flavors, cheesy flavors with minimal increased (or decreased) mold or fungal flavors.

In one embodiment of the invention, flavors and/or tastes of the myceliated substrates are modulated as compared to the meat analog material (starting material). In one embodiment, the aromas of the resultant myceliated substrate prepared according to the invention are reduced and/or improved as compared to the substrate control. In other words, undesired aromas are reduced and/or desired aromas are increased. In another embodiment, flavors and/or tastes may be reduced and/or improved. For example, desirable flavors and/or tastes may be increased or added to the myceliated substrate by the processes of the invention. The increase in desirable flavors and/or tastes may be rated as an increase of 1 or more out of a scale of 5 (1 being no taste, 5 being a very strong taste.)

Culturing times and/or conditions can be adjusted to achieve the desired aroma, flavor and/or taste outcomes. For example, cultures grown for approximately 2 to 20 days can yield a deflavored product whereas cultures grown for longer may develop various aromas that can change/intensify as the culture grows. As compared to the control, the resulting myceliated substrate in some embodiments is less bitter and has a milder, less pea like or less fungal/moldy aroma. In one embodiment, the culture may be grown for 2 days, 3 days, 4 days, 5 days, 6 days, 7 days, 8 days, 9 days, 10 days, 11 days, 12 days, 13 days, 14 days, 15 days or more. In one embodiment, after culturing, the mycelial mass of the mycelia in the substrate is between 0.1% and 1% of the total weight, w/w, or in some embodiments around 0.5%.

In an embodiment, at the end of the culturing time, the inoculated substrate is pasteurized or sterilized in order to inactivate and/or kill the filamentous fungus. Methods for pasteurization and/or sterilization may be carried out as known in the art. As an example of pasteurization, substrates may be subjected to dry heat treatment at atmospheric pressure at 145° F. to 190° F. for 30 to 90 minutes, alternatively at 140° F. to 210° F. for 20-100 minutes, alternatively, 170° F. for three hours

In an embodiment, the texture of the prepared protein food product of the present invention, after cooking, is similar to that of meat and is improved by the process of myceliation. For example, meats such as cooked ground beef or meat crumbles are imitated by mechanically texturized protein. The present invention provides for similar texture as a mechanically texturized protein without the mechanical step. For example, cooked texturized proteins have “spring” upon first bite, where upon first chew the material springs back partially instead of remaining deformed like a paste and also have spring during “chew-down” where springiness continues to be experienced until fully masticated. In a ground-meat patty, such texture is experienced as an initial moderate springiness with low to moderate springiness upon chew-down. In an embodiment, the protein food product of the present invention has similar properties, when cooked, to a ground meat patty. Another parameter of texture is the cohesiveness and cohesiveness of the mass. Cohesiveness is the experience of whether the mass stays together or how much it crumbles; the cohesiveness of the mass is how well the mass forms a bolus upon chewing. Ground-meat patties have low to moderate cohesiveness and cohesiveness of mass. Hardness is another parameter that relates to the degree of force that is required to bite through the product. Ground-meat products have a low hardness. Finally, “tooth pack” refers to whether the material sticks to the molars of the teeth upon chewing; ground-meat patty has a low tooth pack. Tooth stick refers to whether the food causes the teeth to stick together; meat has a low tooth stick. In an embodiment, the protein food product has a low to moderate spring, a low to moderate cohesiveness and cohesiveness of mass, a low to moderate hardness, and low tooth pack and tooth stick. In an embodiment, the texture of the protein food product of the present invention, after cooking, is like a cooked texturized soy protein and/or to a cooked ground beef patty.

The present invention also provides a “meat-like food product” which, as used herein refers to a food product that is not derived from an animal but has structure, texture, and/or other properties, when cooked, comparable to those of cooked animal meat. The term refers to uncooked, cooking, and cooked meat-like food product unless otherwise indicated herein or clearly contradicted by context.

The term “springiness” as used herein refers to a TPA parameter of a food product and is calculated as the ratio of the food product's height during the second compression and the original compression distance, as known in the art. It is thought to correlate with the ability of a food product to spring back after deformation. It can also be measured qualitatively through sensory assessment. In an embodiment, the present invention has a springiness that is comparable to those of animal meat. The term refers to uncooked, cooking, and cooked meat-like food product unless otherwise indicated herein or clearly contradicted by context.

The present invention also provides a “meat structured protein product” in the absence of texturizing. Specifically, the present invention's meat-structured protein product is a product, and product created by the processes of the invention, comprising fiber networks and/or aligned fibers that produce meat-like textures. Conventionally, such meat structured protein products can be obtained from a dough after application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous and/or aligned structure (e.g., by rapid temperature and/or pressure change, rapid dehydration, chemical fixation, redox), and optional post-processing after the fibrous and/or aligned structure is generated and fixed (e.g., hydrating, marinating, drying, coloring). In the present invention, fiber networks and fiber alignments are created by mycelial action and/or mycelia itself, which imparts cohesion and firmness whereas open spaces in the fiber networks and/or fiber alignments may tenderize the meat structured protein products and provide pockets for capturing water, carbohydrates, salts, lipids, flavorings, and other materials that are slowly released during chewing to lubricate the shearing process and to impart other meat-like sensory characteristics.

The one or more similar or superior attributes of animal meat provided by the meat-like products provided herein include but are not limited to color, color stability, cooking color change profile, aroma, aroma stability, cooking aroma release change profile, taste, taste stability, cooking taste change profile, chewiness, chewiness stability, cooking chewiness change profile, springiness, springiness stability, cooking springiness change profile, cohesiveness, cohesiveness stability, cooking cohesiveness change profile, hardness, hardness stability, cooking hardness change profile, juiciness, juiciness stability, cooking juiciness change profile, protein content, lipid content, carbohydrate content, fiber content, and combinations thereof.

A food composition of the invention can be used in place of, or instead of, a texturized protein, such as a texturized plant protein. The mycelial network can provide a product that simulates the fibrous structure of animal meat and provides a cooked product a desirable meat-like moisture, texture, mouthfeel, flavor and color. It can also hold a good deal of moisture to give a juicy and moist mouthfeel.

Texture profile analysis and cutting strength of the above invention can optionally be conducted with a texture analyzer or by sensory assessment. One can assess the springiness, cohesiveness, and chewiness of the myceliated analog samples as known in the art. Cutting strength of both transversal and longitudinal directions of the samples can be assessed by using a cutting probe. For assessment of the myceliated samples of the present invention, such assessment may optionally be done by qualitative sensory techniques, or more quantitatively by use of the following techniques.

In one embodiment of the present invention, the myceliated substrate made by the methods of the invention have a complete amino acid profile (all amino acids in the required daily amount) because of the substrate from which it was made has such a profile. While amino acid and amino acid profile transformations are possible according to the methods of the present invention, many of the products made according to the methods of the present invention conserve the amino acid profile while at the same time, more often altering the molecular weight distribution of the proteome.

The present invention also includes a protein food product comprising the myceliated substrate made by any of the methods as disclosed herein. Alternatively, the invention comprises a myceliated substrate for human or animal consumption, wherein the composition comprises a grain, a plant protein or isolate, wherein the composition is at least 20% protein by weight or at least 40%, 45%, 50%, 55%, or 60% protein by dry weight, and a filamentous fungus, wherein the composition exhibits hyphae and a mycelial network extending throughout the composition, wherein the composition is more cohesive than a control composition not comprising a filamentous fungus, and wherein the composition has reduced undesirable flavors and reduced undesirable aromas compared to a control composition not comprising a filamentous fungus.

“Myceliated” as used herein, means a meat analog material as defined herein having been cultured with live fungi as defined herein and achieved at least a 1%, at least 2%, at least 3%, at least 4%, at least a 5%, at least a 10%, at least a 20%, at least a 30%, at least a 40%, at least a 50%, at least a 60%, at least a 70%, at least a 80%, at least a 90%, at least a 100%, at least a 120%, at least a 140%, at least a 160%, at least a 180%, at least a 200%, at least a 250%, at least a 300%, at least a 400%, at least a 500% increase in biomass or more, to result in a myceliated meat analog food product.

Such prepared myceliated substrates or protein food products can be used to as a substitute or extender for ground meats or chopped/diced meats, and can be used in many recipes such as taco meats, Italian sausage/crumbles, lasagna, pasta sauces, dumplings, meat fillings, meat pot pies, formed meat patties such as hamburger, chickenburger, fish burgers, meat loaf, chili, meat casseroles, and the like, using methods known in the art.

The composition may further comprise, without limitation, a starch, a flour, a grain, a lipid, a colorant, a flavorant, an emulsifier, a sweetener, a vitamin, a mineral, a spice, a fiber, a protein powder, nutraceuticals, sterols, isoflavones, lignans, glucosamine, an herbal extract, xanthan, a gum, a hydrocolloid, a preservative, a legume product, a food particulate, and combinations thereof. A food particulate can include cereal grains, cereal flakes, crisped rice, puffed rice, oats, crisped oats, granola, wheat cereals, protein nuggets, texturized plant protein ingredients, flavored nuggets, cookie pieces, cracker pieces, pretzel pieces, crisps, soy grits, nuts, fruit pieces, corn cereals, seeds, popcorn, yogurt pieces, and combinations of any thereof.

Edible fiber can be included in the substrate and fiber tends to bind water. Any appropriate type of edible fiber may be used in the present invention in appropriate amounts. Exemplary sources of edible fiber include soluble and insoluble dietary fiber, wood pulp cellulose, modified cellulose, seed husks, oat hulls, citrus fiber, carrot fiber, pea fiber, corn bran, soy polysaccharide, oat bran, wheat bran, barley bran, and rice bran. The fiber may be present in the dry pre-mix from about 0.1% to about 10% by weight. In one embodiment, the fiber is about 2% to about 8% by weight of the dry ingredients. In another embodiment the fiber is about 5% by weight of the dry ingredients.

In accordance with the present disclosure, nearly any edible lipid material may be employed, including natural and synthetic oils, for example, rapeseed, canola, soybean, cottonseed, peanut, palm and corn oils and in either non-hydrogenated or hydrogenated form. In one embodiment, the edible lipid material is an edible vegetable oil, such as canola oil. cottonseed oil, peanut oil, and olive oil.

In one embodiment, the total edible lipid content is no more than about 5% of the weight of the dry ingredients utilized the make the meat analog product. As such, in one embodiment, the total edible lipid content is an amount of about 0.1% to about 1% by weight of the dry ingredients. In another embodiment, the total edible lipid content is an amount of about 0.2% to about 0.5% by weight of the dry ingredients.

In addition to the foregoing, the meat analog product includes water at a relatively high amount. In one embodiment, the total moisture level of the mixture is controlled such that the meat analog product has a moisture content that is at least about 1.5 ml per g of dry weight substrate. To achieve such a high moisture content, water is typically added to the ingredients.

Seasonings can be added before or after the culturing step. Seasonings include, but are not limited to, minerals such as salt, grain-based seasonings (such as, but not limited to, whole, cracked or ground wheat, corn, oats, rye, flax, barley, spelt and rice), plant-derived seasonings (such as, but not limited to, onion, garlic, pepper, capsicum pepper, herbs, spices, nuts, olives, fruits, vegetables, etc.), and other flavorings (such as, but not limited to, vanilla, sugar, cheese, yeast extract, whey), and combinations thereof. Vitamins can also be included such as, but not limited to, niacin, iron, zinc, thiamine mononitrate (vitamin B1), riboflavin (vitamin B2), folic acid, tocopherol(s) (vitamin E), vitamin C, vitamin B6, vitamin B12, vitamin A, vitamin D, pantothenic acid and copper. Edible oil and fat can also be included. Oils such as, but not limited to, soy, corn, canola, sesame, safflower, olive, sunflower, rapeseed, cottonseed, peanut, copra, palm kernel, palm, linseed, lupin, and combinations thereof can be used. Other fats such as butter or lecithin and their mixtures can also be used. Other ingredients can be included such as emulsifiers (such as, but not limited to, lecithin, soy lecithin), leavening (such as, but not limited to, baking soda, calcium phosphate, yeast), natural and artificial sweeteners, preservatives (such as, but not limited to, BHT, BHA, and tocopherol), fiber (such as, but not limited to, insoluble fiber, soluble fiber (e.g., Fibersol®)), and any combinations of such ingredients.

The product may additionally comprise, consist of, or consist essentially of one or more (e.g., a mixture) of vegetables and/or fruits materials or substances. The vegetable/fruit materials or substances to include in the aqueous media can be obtained from any of several vegetable or fruit sources and can include one or more of the vegetables/fruits in whole form (fresh), as extracts, or dried or partially dried form from whole vegetables or extracts, e.g., powders. Vegetables and fruits suitable for the present invention include any prepared from a vegetarian source such as carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof. A typical vegetable/fruit powder is typically dried or spray dried and is available in a powdered form and may alternatively be called “vegetable powder.”

In various embodiments, the processing conditions and the amounts and types of ingredients can be modified to change the nutritional levels of the finished product, as well as for altering the handling, stability, shelf life, texture, flavor, functional properties and ease of manufacture of the product. Flavoring agents as described above may be sprinkled, brushed, or otherwise applied to the product during other steps in the process. For example, at various points during the processes described herein, the product may be sprayed with oil or an edible no-fat, low-fat or reduced fat edible adhesive. The oil or adhesive is used to increase palatability and to provide a medium for the adhesion of the above-described flavoring agents. The flavoring agents may be applied after spray coating with the oil or adhesive or they may be applied together, for example, as a slurry. The products may also be optionally subjected to tumbling during the spraying and/or during the addition of the particulate additives and agents.

A food composition of the invention can be used in place of, or instead of, a texturized protein, such as a texturized plant protein. The mycelial network can provide a product that simulates the fibrous structure of animal meat and has a desirable meat-like moisture, texture, mouthfeel, flavor and color. It can also hold a good deal of moisture to give a juicy and moist mouthfeel.

As referred to herein, all compositional percentages and ratios are by weight of the total composition, unless otherwise specified.

### EXAMPLES

### Example 1

Three (3) solid-state substrates were prepared in polypropylene bags with 0.2 μm breather patches. The 1^{st} substrate contained 330 g organic short grain brown rice, 170 g of an 80% pea protein concentrate and had 100 mL RO water added to it. The 2^{nd} substrate contained 315 g organic short grain brown rice, 185 g of an 80% pea protein concentrate and had 150 mL RO water added to it. The 3^{rd} substrate contained 300 g organic short grain brown rice, 150 g of an 80% pea protein concentrate and had 200 RO mL water added to it. The purpose of this preparation was to test a water content gradient across the substrate at constant protein levels. Subsequently, substrate containing 500 g organic short grain brown rice and 100, 150 and 200 mL RO water added were made for a total of 6 different substrates. Two (2) bags of each substrate were prepared and sterilized. Each bag was inoculated with 100 mL of a 20 day Lentinula edodes liquid tissue culture and agitated. Post inoculation the moisture gradient across RO water additions was calculated to be 32, 37 and 42% with a protein content of ˜26%. The bags were left stationary and cultured at RT for 2 weeks at room temperature. It was noted that the substrate containing just rice (no protein) myceliated at every moisture level and did so more vigorously at higher moisture levels. The substrate containing protein did not myceliate under any processing conditions.

### Example 2

A medium was prepared in a 1 L beaker containing 30 g of an 80% pea protein concentrate, 17 g organic short grain brown rice, 3 g of a high protein yeast extract and 40 mL water. The beaker was covered with tin foil and sterilized. The beaker was then inoculated with 10 mL of sterile RO water containing ˜0.05 g of macerated Cantharellus cibarius. The culture was calculated to be ˜52% water and ˜30% protein. A control beaker was prepared, not inoculated and had 10 mL of sterile RO water with no tissue added at this point. Both beakers were sealed and were allowed to myceliate at room temperature on the benchtop in a normal day/night light schedule. The inoculated beaker was fully colonized by 5 days, at which point ˜15 g of both the myceliated and control samples were cooked in canola oil in a stovetop heated steel pan. It was noted that the myceliated sample held together much more effectively than the control sample, which was extremely crumbly. Each sample was tasted by 5 people and all agreed that the myceliated sample had far fewer off-notes and taste much better than the control sample (e.g. had less aftertaste, was more savory).

### Example 3

A flask containing 54 g/L cane sugar and 14 g/L pea protein was sterilized and inoculated with Morchella esculenta grown on grain that had been stored in glycerol at −80° C. Approximately 8 grams of this glycerol stock culture was transferred into the flask. The inoculated flask incubated on a shaker table at 24° C. and 120 RPM for 14 days. The ring that was forming around the flask was knocked down with vigorous shaking by hand at day 5 and ultimately formed a ball of biomass in the flask approximately 1-2 inches in diameter. This ball was macerated prior to use as inoculant.

Three (3) autoclave bags containing a mixture of ˜35% pea protein concentrate, ˜18% short grain brown rice and ˜47% RO water were sterilized in an autoclave and inoculated with 25 mL of the macerated culture discussed in the previous paragraph. These inoculated bags were incubated at 24° C. for 11 days, whereupon it was noticed that the mycelium had fully colonized the media and was composed mostly of balls/chunks of myceliated rice/pea protein anywhere from 0.1-4 inches in diameter, though some free grain and protein remained. These balls/chunks were noted to feel resistant to compression when pinched between finger and thumb, especially compared to the material as it was initially prepared. The bags were double bagged and set in boiling water for 5 minutes to pasteurize the M. esculenta and as a general food safety measure. The inventors were surprised to find that when cooked on a cast-iron skillet on medium heat for about 10 minutes and eaten these myceliated balls of rice and pea protein had a texture similar to ground beef, as well as an umami, savory taste with no typical pea protein aroma and very little pea or rice aroma. One taster considered it indistinguishable from cooked ground beef. Every taster enjoyed the material though some found it a little dry.

### Example 4

A flask containing 54 g/L cane sugar and 14 g/L pea protein was sterilized and inoculated with Morchella esculenta grown on grain that had been stored in glycerol at −80° C. Approximately 8 grams of this glycerol stock culture was transferred into the flask. The inoculated flask incubated on a shaker table at 24° C. and 120 RPM for 14 days. The ring that was forming around the flask was knocked down with vigorous shaking by hand at day 5 and ultimately formed a ball of biomass in the flask approximately 1-2 inches in diameter. This ball was macerated prior to use as inoculant.

Three (3) autoclave bags containing a mixture of ˜35% pea protein concentrate, ˜18% short grain brown rice and ˜47% RO water were sterilized in an autoclave and inoculated with 25 mL of the macerated culture discussed in the previous paragraph. These inoculated bags were incubated at 24° C. for 11 days, whereupon it was noticed that the mycelium had fully colonized the media and was composed mostly of balls/chunks of myceliated rice/pea protein anywhere from 0.1 to 4 inches in diameter, though some free grain and protein remained. These balls/chunks were noted to feel resistant to compression when pinched between finger and thumb, especially compared to the material as it was initially prepared. The bags were double bagged and set in boiling water for 5 minutes to pasteurize the M. esculenta and as a general food safety measure. Once pasteurized, a mixture of 2:1 refined coconut oil and sunflower oil was heated until the oils were mixed and then added to the myceliated material to a final concentration of 8%. When cooked the material had increased umami and savory flavors, as before, with the inventors considering the added fat contributing greatly to the taste and mouthfeel of the product.

### Example 5

A flask containing 54 g/L cane sugar and 14 g/L pea protein was sterilized and inoculated with Morchella esculenta grown on grain that had been stored in glycerol at −80° C. Approximately 8 grams of this glycerol stock culture was transferred into the flask. The inoculated flask incubated on a shaker table at 24° C. and 120 RPM for 14 days. The ring that was forming around the flask was knocked down with vigorous shaking by hand at day 5 and ultimately formed a ball of biomass in the flask approximately 1-2 inches in diameter. This ball was macerated prior to use as inoculant.

Three (3) autoclave bags containing a mixture of ˜35% pea protein concentrate, ˜18% short grain brown rice and ˜55% RO water were sterilized in an autoclave and inoculated with 25 mL of the macerated culture discussed in the previous paragraph. These inoculated bags were incubated at 24° C. for 11 days, whereupon it was noticed that the mycelium had fully colonized the media and was composed mostly of balls/chunks of myceliated rice/pea protein anywhere from 0.1-4 inches in diameter, though some free grain and protein remained. These balls/chunks were noted to feel resistant to compression when pinched between finger and thumb, especially compared to the material as it was initially prepared. The bags were double bagged and set in boiling water for 5 minutes to pasteurize the M. esculenta and as a general food safety measure.

Sample (sham myceliated) control had the quality of color, caramel, toffee brown, and had an aroma soy milk/grain, cardboard. The myceliated material (uncooked) had a color of cocoa brown; aroma, earthy, dirt, raw mushroom; and a texture, springy, rubbery when compressed, dense, didn't break when compressed. Sample (sham myceliated) control, when cooked for 5 minutes 195° F.; color was caramel, toffee brown (unchanged from control); aroma was very low, with a slight cooked Maillard reaction; texture was crunchy, very dense, no spring, and had fracturability in small pieces, and high cohesion. Flavor of the cooked control was mostly flavorless, with a very slight cardboard, nutty flavor (very low at backend). Sample myceliated material, was cooked for 5 minutes, 180° F. with the color of well done, burnt meat; aroma, cooked rice, toasted mushroom, slight earthy; texture was dense, springy, slightly spongy, mid cohesiveness of mass, and crust formation was crisp but thin. Flavor was neutral flavor, Maillard sweetness, meaty/savory, savory linger.

### Example 6

To the material made in Example 5, the following color additives are added to create a look that is more like meat: betanin, beet juice contrate, beet powder, lycopene, tomato juice concentrate, tomato powder, annatto, at between 0.01-0.1% w/w. An antioxidant such as vitamin C is added up to 2% w/w.

### Example 7

Agar Plate

Dextrose (15 g/L), yeast extract for media (6.5 g/L) and food grade agar (15 g/L) and water were autoclaved, cooled, and made into plates using sterile procedure. Once solidified, 500 μl of blended (Waring Commercial Blender, blend at high speed for 5-10 seconds, as needed to render homogenized culture capable of being drawn into a pipette for transfer) Morchella esculenta inoculum (obtained from strain WC 833, commercially available from The Pennsylvania State University Mushroom Culture Collection, available from the College of Agriculture Sciences, Department of Plant Pathology and Environmental Microbiology, 117 Buckhout Laboratory, The Pennsylvania State University, University Park, Pa., USA 16802) and the phylogenetic identity of the culture was confirmed by ITS (internal transcribed spacers) analysis (data not shown) as M. esculenta, was added to a plate, spread with a sterile loop, and incubated at 26° C. To check for bacterial contamination, LB plates—Luria-Broth (25 g/L) and agar (15 g/L) were used to check the inoculum. To check for fungal/mold contamination, MYPG plates—malt extract (10 g/L), yeast extract (4 g/L), peptone (1 g/L), glucose (4 g/L) and agar (15 g/L) were used to check the inoculum.

Inoculum

A 500 ml flask was autoclaved with 250 ml of dextrose (15 g/L) and yeast extract (6.5 g/L). The flask was inoculated with mycelium from a fully grown agar plate of M esculenta as discussed above. The flask was left stationary at 26° C.; after two weeks incubation, the entire contents of the flask were blended until homogenous (Waring Commercial Blender, blend at high speed for 5-10 seconds, as needed to render homogenized culture capable of being drawn into a pipette for transfer). Final biomass was approximately 3 g/1. A 2 L flask was autoclaved with 1 L of dextrose (15 g/L) and yeast extract (6.5 g/L) and was inoculated with 4% of the blended inoculum. This flask was incubated at 26° C. for three weeks.

Substrate

A mixture of 1140 g of pea protein concentrate (≥80% protein by weight, moisture ≤8.0%, obtained from Yantai T. Full Biotech Col, Ltd., Zhaoyuan City, China), 180 g of quinoa (organic white quinoa, grain size >70% retained on ASTM 14 (1.4 mm, obtained from Colorexa, Lima, Peru) and 180 g of dried short grain brown rice (Blue Mountain Organics Distribution, LLC, Floyd, Va.; brown short grain rice, moisture of 11 to 15%) were added to a 13″×22″ polypropylene 6-strip bag (Out-Grow.com, Mcconnell, Ill., Large Six Strip Mushroom Grow Bag) and mixed to evenly distribute the contents. 1950 ml of RO water was added and mixed thoroughly until the media was as homogenous as possible. The bag was then autoclaved, 121° C., for 4 hours, or 132° C., for 1 hour. The media was cooled to <27° C. (overnight) and then crumbled (by hand) before adding the inoculum.

Solid-State Fermentation

The 1 L stationary flask of M. esculenta was blended until homogenous and 180 ml of the blended inoculum was added to the crumbled media. The bag was sealed and mixed thoroughly to incorporate the blended inoculum into the media. At day 3 and 6 of the fermentation, the bag was mixed again by gently shaking the contents inside the bag, by hand. The bag was left at 26° C. for 10 days or 13 days. At 10 days, a small sample of fermented material was removed from the bag and plated to LB and MYPG plates. The LB plates were negative for bacteria and the MYPG plates showed the presence of fungus (M esculenta). The bag was then pasteurized at 70° C. for 3 hours. A small sample was again removed from the bag and plated to LB and MYPG plates. The post-pasteurization plates showed no bacteria on the LB plates and no fungus or mold on the MYPG plates. Final mycelial mass of the substrate was estimated at about 0.5% w/w.

10-Day Old Fermented Product (after Cooking)

Appearance—light brown, irregular shaped, small crumble, varying from the size of a rice grain to a dime (when cooked looks like ground beef).

Flavor—High levels of umami, slight earthy undertones, slight pea flavor, no bitterness.

Texture—Soft to chewy, meat-like chew, moist, slight chalky.

Aroma—Slightly mushroom, slight earthy, bean-like, very little typical pea aroma.

13-Day Old Fermented Product:

Appearance—Dark brown, irregular shaped, large crumble, ranging from the size of a dime to a quarter (when cooked looks well done grilled meat).

Flavor—Strong mushroom, more umami, well rounded, less bean/pea flavor.

Texture—Medium-well to well done meat, drier, stronger bite, no chalkiness.

Aroma—Mushroom, less earthy, less bean like, more mild, slight sweet, very little typical pea aroma.

Potential Benefits—Unique texture, solid state fermentation, texturized within fermentation versus extruded like texturized plant protein. Umami core flavor.

Target applications—Ground beef replacement/Sausage/Taco meat, Jerky, Sausage (casing possible), Pre-molded products, Bacon bits, Freeze dried additions to dry soups or savory snack mixes.

Proximate analysis performed by standard techniques by a third party testing laboratory shows that per 20 g serving, the material made by the method of Example 8 has 35.1 cal/serving, with fat as 6.75 cal/serving; fat (by acid hydrolysis) is 0.75 g/serving; carbohydrates are 1.1 g/serving; protein (N×6.25) Dumas method is 5.96 g/serving; ash is 0.37 g/serving; and moisture is 11.8 g/serving.

### Example 8

Agar Plate

Dextrose (15 g/L), yeast extract for media (6.5 g/L) and food grade agar (15 g/L) and water were autoclaved, cooled, and made into plates using sterile procedure. Once solidified, 500 ul of blended (Waring Commercial Blender, blend at high speed for 5-10 seconds, as needed to render homogenized culture capable of being drawn into a pipette for transfer) Morchella esculenta inoculum (obtained from strain WC 833, commercially available from The Pennsylvania State University Mushroom Culture Collection, available from the College of Agriculture Sciences, Department of Plant Pathology and Environmental Microbiology, 117 Buckhout Laboratory, The Pennsylvania State University, University Park, Pa., USA 16802) and the phylogenetic identity of the culture was confirmed by ITS (internal transcribed spacers) analysis (data not shown) as M. esculenta, was added to a plate, spread with a sterile loop, and incubated at 26° C. To check for bacterial contamination, LB plates—Luria-Broth (25 g/L) and agar (15 g/L) were used to check the inoculum. To check for fungal/mold contamination, MYPG plates—malt extract (10 g/L), yeast extract (4 g/L), peptone (1 g/L), glucose (4 g/L) and agar (15 g/L) were used to check the inoculum.

Inoculum

A 500 ml flask was autoclaved with 250 ml of dextrose (15 g/L) and yeast extract (6.5 g/L). The flask was inoculated with mycelium from a fully grown agar plate of M esculenta as discussed above. The flask was left stationary at 26° C.; after two weeks incubation, the entire contents of the flask were blended until homogenous (Waring Commercial Blender, blend at high speed for 5-10 seconds, as needed to render homogenized culture capable of being drawn into a pipette for transfer). Final biomass was approximately 2 g/ml. A 2 L flask was autoclaved with 1 L of dextrose (15 g/L) and yeast extract (6.5 g/L) and was inoculated with 4% of the blended inoculum. This flask was incubated at 26° C. for three weeks.

Substrate

A mixture of 1140 g of pea protein concentrate (≥80% protein by weight, moisture ≤8.0%, obtained from Yantai T. Full Biotech Col, Ltd., Zhaoyuan City, China), 78 g of chickpea flour, (obtained from Anthony's Goods, Glendale, Calif.) and 360 g of dried short grain brown rice (Blue Mountain Organics Distribution, LLC, Floyd, Va.; brown short grain rice, moisture of 11 to 15%) were added to a 13″×22″ polypropylene 6-strip bag (Out-Grow.com, Mcconnell, Ill., Large Six Strip Mushroom Grow Bag) and mixed to evenly distribute the contents. 1950 ml of RO water was added and mixed thoroughly until the media was as homogenous as possible. The bag was then autoclaved, 121° C., for 4 hours. The media was cooled to <27° C. (overnight) and then crumbled (by hand) before adding the inoculum.

Solid-State Fermentation

The 1 L stationary flask of M. esculenta was blended until homogenous and 180 ml of the blended inoculum was added to the crumbled media. The bag was sealed and mixed thoroughly to incorporate the blended inoculum into the media. At day 3 and 6 of the fermentation, the bag was mixed again by gently shaking the contents inside the bag, by hand. The bag was left at 26° C. for 10 days. At 10 days, a small sample of fermented material was removed from the bag and plated to LB and MYPG plates. The LB plates were negative for bacteria and the MYPG plates showed the presence of fungus (M. esculenta). The bag was then pasteurized at 70° C. for 3 hours. A small sample was again removed from the bag and plated to LB and MYPG plates. The post-pasteurization plates showed no bacteria on the LB plates and no fungus or mold on the MYPG plates. Proximate analysis performed by standard techniques by a third party testing laboratory shows that per 20 g serving, the material made by the method of Example 8 has 38.2 cal/serving, with fat as 2.77 cal/serving; fat (by acid hydrolysis) is 0.3 g/serving; carbohydrates are 2.9 g/serving; protein (N×6.25) Dumas method is 5.99 g/serving; ash is 0.71 g/serving; and moisture is 10.1 g/serving.

### Example 9

Testing of formulations with M. esculenta. Ingredient information provided in Example 7 and Example 8. Amount of inoculum is proportionally the same as Example 7. Number 1-3 below were fermented for 10 days, No. 4-6 were fermented for 12 days. 11 and 12 are controls (no inoculum). Materials were browned in oil and cooked to 165° F. internal temperatures. Results showed that inoculated materials are significantly preferred and more highly rated than non-inoculated materials. Both flavor and texture are improved upon treatment. 10 day fermentation is better than 13-day. The results are summarized in Table 1.

TABLE 1

| | | Short | | | | | |
|---|---|---|---|---|---|---|---|
| | Pea | grain | | | | | |
| | protein | brown | | | | | |
| Sample | conc | rice | Quinoa | Chickpea | | | Overall |
| # | (g) | (g) | (g) | flour (g) | Flavor | Texture | rating |
| 1 | 190 | 60 | 0 | 13 | Fungal | No spring, low | 6 |
| | | | | | upfront, | cohesion of mass, | |
| | | | | | slightly sour, | tooth stick, soft | |
| | | | | | pea like, | cohesive | |
| | | | | | fermented, | | |
| | | | | | astringent | | |
| 2 | 190 | 60 | 0 | 13 | Sour, mostly | Mid-low spring, tooth | 6 |
| | | | | | neutral | stick, tooth pack, low | |
| | | | | | | cohesiveness of mass | |
| 3 | 190 | 0 | 60 | 6 | Neutral, | High spring, mid | 8 |
| | | | | | sweet, fungal | cohesiveness, good | |
| | | | | | | hold, slight tooth | |
| | | | | | | stick no tooth pack, | |
| | | | | | | “like meat” | |
| 4 | 190 | 60 | 0 | 13 | pea/sour, | high spring, high | 6 |
| | | | | | slightly | tooth stick, mid/low | |
| | | | | | sweet, | cohesiveness of mass, | |
| | | | | | moderate | mealy | |
| | | | | | neutral | | |
| 5 | 190 | 60 | 0 | 13 | neutral, slight, | crust, high density | 6 |
| | | | | | sweet, slight | high spring, mealy, | |
| | | | | | fungal, slight | less cohesive than | |
| | | | | | umami, pea | meat, low | |
| | | | | | backend | cohesiveness of mass, | |
| | | | | | | mid cohesive | |
| 6 | 190 | 0 | 60 | 6 | sweet, | hard, low | 8 |
| | | | | | umami, | cohesiveness of mass, | |
| | | | | | cooked grain | high spring, high | |
| | | | | | | density, crust | |
| | | | | | | formation | |
| 11 | 190 | 60 | 0 | 13 | neutral | no browning, | 2 |
| | | | | | upfront, no | crumbly, low spring, | |
| | | | | | flavor, rice | slight crust, tooth | |
| | | | | | protein | stick, low | |
| | | | | | backend | cohesiveness of mass, | |
| | | | | | | no spring | |
| 12 | 190 | 60 | 0 | 0 | neutral | mid spring, slight | 2 |
| | | | | | upfront, no | crust, low | |
| | | | | | flavor, rice | cohesiveness, low | |
| | | | | | protein | cohesiveness of mass | |
| | | | | | backend, | | |
| | | | | | rancid | | |

### Example 10

Testing of formulations with M. esculenta. Ingredient information provided in Example 7 and Example 8. Materials were browned in oil and cooked to 165° F. internal temperatures. Amount of inoculum is proportionally the same as Example 7; fermented for ten days. The results are summarized in Table 2.

TABLE 2

| | | Short | | | | | |
|---|---|---|---|---|---|---|---|
| | Pea | grain | | | | | |
| | protein | brown | | | | | |
| Sample | conc | rice | Quinoa | Chickpea | | | Overall |
| # | (g) | (g) | (g) | flour (g) | Flavor | Texture | rating |
| 1 | 190 | 60 | 0 | 13 | low | moderate spring, | 9 |
| | | | | | intensity | soft, cohesive, | |
| | | | | | flavor, | moderate | |
| | | | | | neutral, | cohesiveness of | |
| | | | | | sweet, | mass, tooth stick | |
| | | | | | umami, | | |
| | | | | | bitter | | |
| | | | | | (slightly), | | |
| | | | | | not a lot of | | |
| | | | | | pea and | | |
| | | | | | rice | | |
| 2 | 190 | 60 | 30 | 0 | sweet, | crust, cohesive, | 8 |
| | | | | | umami, | charred, low | |
| | | | | | salty, low | cohesiveness of | |
| | | | | | flavor | mass, bite down | |
| | | | | | (overall) | moderate spring, | |
| | | | | | | moderate spring | |

### Example 11

Summary of testing results. Materials were browned in oil and cooked to 165° F. internal temperatures. Tested protein food product with three different substrates (medias); a. Pea protein and whole grain brown rice, b. Pea protein, whole grain brown rice, chickpea protein c. Pea protein and quinoa (as shown in above Examples). All three medias showed an overall neutral flavor profile, with a slight background of pea and mushroom. Continuing with the testing, media b and media c were selected to move forward due to better “meat-like” structure. Although the media did not completely represent the true sensory description of meat the media showed; high to moderate cohesiveness, moderate cohesiveness of mass, moderate to high spring, moderate spring on chew down, moderate density, moderate tooth pack, low juiciness. Media 3, pea protein and quinoa, was the most preferred media out of the 3 medias due to high cohesiveness, high juiciness, and high spring. Both media 2 and media 3 continued to produce an overall low flavor profile through testing. Aroma of both media is high pea, cereal, earthy, and mushroom, but did not impact flavor. Therefore, the flavor did not show high earthy, cereal, pea and mushroom notes. Appearance for media 2 was medium-dark brown, crumbles were heterogenous and circular/oblong shaped that ranged from 2 cm-10 cm in sizes in width. When media 2 was cooked crumbles caramelized and became darkly charred. Appearance for media 3 was light-medium brown, crumbles were heterogenous and circular/oblong shaped that ranged from 2 cm-10 cm in sizes in width. When media 3 was cooked the crumbles caramelized and became partially charred.

### Example 12

Testing of Tremella fuciformis (snow fungus). Carried out in same way as Example 7, except substituted T. fuciformis for M. esculenta; fermented for ten days. Materials were browned in oil and cooked to 165° F. internal temperatures. This fungus provided undesirable flavors with a flavor of sour, funky, stinky, over-fermented and stinky/fishy aroma; texture had moderate spring, soft, low cohesiveness of mass, low cohesiveness.

### Example 13

Pleurotus ostreatus testing. Carried out in same way as Example 7, except substituted Pleurotus ostreatus for M. esculenta; fermented for ten days or seven days. Materials were browned in oil and cooked to 165° F. internal temperatures. This fungus showed undesirable results, with a 10 day fermentation having flavor of musky, fishy, wet dog, salt, umami, woody, lingering musk, slight astringent, and stinky/fishy/pea aroma; texture had cohesive, moderate cohesiveness of mass, “jelly”, low spring, crunchy outside. 7 day fermentation resulted in flavor neutral, sweet, fishy background, umami, salt, meaty quality, astringent, cooked grain, fishy aftertaste, moderate lingering, moderate flavor intensity and aroma fishy/stinky/pea, with texture low cohesiveness, high spring, little tooth pack, moderate cohesiveness of mass.

### Example 14

Pleurotus eryngii (king oyster) testing. Carried out in same way as Example 7, except substituted Pleurotus eryngii for M. esculenta; fermented for ten days or seven days. Materials were browned in oil and cooked to 165° F. internal temperatures. This fungus showed undesirable results, with a 7 day fermentation having flavor of sour, fermented notes, fishy, stinky, blue cheese, butyric acid, high umami, very bitter, very funky, and fish/rotten compost aroma; texture had no spring, low/no cohesiveness, no chew, high cohesiveness of mass, pasty, no texture. 7 day fermentation resulted in flavor bitter, high butyric acid, sour, bitter, funky afternotes, no umami linger and aroma of fish/rotten compost, with texture no spring, low cohesiveness of mass, no chew, high toothstick, residual pieces.

### Example 15

Pleurotus djamor (pink oyster) testing. Carried out in same way as Example 7, except substituted Pleurotus djamor for M. esculenta; fermented for four days, six days or seven days. Materials were browned in oil and cooked to 165° F. internal temperatures. This fungus showed less desirable results compared with M. esculenta, with a 4 day fermentation that had flavor of rice, mushroom backend, little umami, no bitter, no sour, no intensity of flavor, bland, low flavor profile, lighter density, and pea/neutral aroma; texture had squishy, high/moderate cohesiveness, spring on chew down, low cohesiveness of mass, moderate spring. 6 day fermentation had flavor of high mushroom, moderate fishy, moderate stink, moderate flavor intensity, salt backend, no sour, no bitter, umami linger, and pea/neutral aroma; texture had dense, spring on chew down, low cohesiveness, mushy, moist, low cohesiveness of mass, low spring. 7 day fermentation resulted in flavor mushroom, umami backend, smokey, oil retentive/oil abuse flavor and aroma of pea, neutral, with texture high/moderate spring, partial compression, low cohesiveness of mass, spring on chew down, cohesive, moderate spring, crust.

### Example 15

Hericium erinaceus (Lion's mane) testing. Carried out in same way as Example 7, except substituted Hericium erinaceus for M. esculenta; fermented for seven days. Materials were browned in oil and cooked to 165° F. internal temperatures. This fungus showed undesirable results, with a 7 day fermentation having flavor of sour, urea, ammonia, over fermented, funky, little bitter, mushroom, smokey, and stinky, fungal aroma; texture had no spring, low/no cohesiveness, no chew, high COM, pasty, no texture. 7 day fermentation resulted in flavor bitter, high butyric acid, sour, bitter, funky afternotes, no umami linger and aroma of fish/rotten compost, with texture crumbly, mushy, not cohesive, pasty, no structure, melts apart, no cohesiveness of mass.

### Example 16

Applications.

A) Sausage. To create a sausage from the protein food product prepared by the method of Example 7, the following procedure was used. To the protein food product, add the flavors and half the water, and mix for 3 minutes. Add methylcellulose and the other half of the water and mix. Add canola oil and methylcellulose and mix. Spread thinly on pan and freeze for 20 minutes. Use table top meat grinder with sausage attachment and add to an edible cellulose casing and section off into individual sausages and freeze. To cook, fill a medium frying pan to about 1 cm depth of water, heat to a simmer, add sausages and cook, rotating occasionally, until water is evaporated. Add more water and continue to cook until the internal temperature is 150° F. Then brown sausage until internal temperature is 165° F. and serve. The components are shown in Table 3 and the nutritional information is shown in Table 4.

TABLE 3

| Material | gram |
|---|---|
| Protein food product according to Example 7 | 42.2 |
| Methylcellulose, Wellence Vege Form 183 | 0.5 |
| Pork Flavor, Innovaflavors #118-3891 | 2.2 |
| Garlic powder | 0.6 |
| Vital wheat gluten | 1.0 |
| Canola oil | 11.50 |
| Protein concentrate powder | 2.0 |
| ClearTaste ™ M360 essential (available from | 0.25 |
| MycoTechnology, Inc.) | |
| Gel system | 23 g |
| Water | 15.5 |

TABLE 4
Nutritional information (as-cooked)

| | |
|---|---|
| Serving size (g) | 101 |
| Calories | 250 |
| Total fat (g) | 18 |
| Saturated fat (g) | 1.5 |
| Sodium (mg) | 330 |
| Carbohydrates (g) | 5 |
| Fiber (g) | 1 |
| Sugar (g) | 0 |
| Added sugar (g) | 0 |
| Protein (g) | 15 |

Sausage cooked according to the directions above was considered highly palatable and tasty, and very similar in taste and texture to sausages containing meat.

B) Taco meat. To create taco meat from the protein food product prepared by the method of Example 7, the protein food product, is mixed with the flavorings and seasoning and mixed until the protein food product is in pieces of 0.25 to 0.5 inches in diameter. To cook, the mixture is pan-fried in a small amount of oil until browned. Components are shown in Table 5. Nutritional information is shown in Table 6.

TABLE 5

| | % by weight | |
|---|---|---|
| Material | (wet weight) | gram |
| Protein food product according to Example 7 | 42.8 | 42.83 |
| Beef flavor Springarom BF 7004 | 0.72 | 0.72 |
| Chicken flavor Springarom CK 7005 | 0.72 | 0.72 |
| Taco Mixture Seasoning | 8.29 | 8.29 |

TABLE 6
Nutritional information (as-cooked)

| | |
|---|---|
| Serving size (g) | 100 |
| Calories | 90.62 |
| Total fat (g) | 1.6 |
| Saturated fat (g) | 0.3 |
| Sodium (mg) | 83.0 |
| Carbohydrates (g) | 9.5 |
| Fiber (g) | 0.1 |
| Sugar (g) | 0.1 |
| Added sugar (g) | 0.0 |
| Protein (g) | 15.06 |

Taco “meat” cooked according to the directions above was considered highly palatable and tasty, and very similar in taste and texture to taco meat containing meat.

C) Italian Crumbles. To create Italian-style ground “beef” from the protein food product prepared by the method of Example 7, the protein food product, is mixed with the flavorings and seasoning and mixed until the protein food product is in pieces of 0.25 to 0.5 inches in diameter. To cook, the mixture is pan-fried in a small amount of oil until browned. Components are shown in Table 7. Nutritional information is shown in Table 8.

TABLE 7

| Material | gram |
|---|---|
| Protein food product according to Example 7 | 42.83 |
| Beef flavor Springarom BF 7004 | 0.72 |
| Chicken flavor Springarom CK 7005 | 0.72 |
| Seasoning, Italian essence | 8.29 |

TABLE 8
Nutritional information (as-cooked)

| | |
|---|---|
| Serving size (g) | 98 |
| Calories | 160 |
| Total fat (g) | 3.5 |
| Saturated fat (g) | 0 |
| Sodium (mg) | 280 |
| Carbohydrates (g) | 5 |
| Fiber (g) | 2 |
| Sugar (g) | 0 |
| Added sugar (g) | 0.0 |
| Protein (g) | 27 |

Italian crumbles cooked according to the directions above was considered highly palatable and tasty, and very similar in taste and texture to Italian crumbles containing meat.

D) Dumplings “meat” and dumplings. Blanch bok choy 1 minute and chop fine. In mixer combine meat analog, flavors, ginger, garlic, soy sauce, rice vinegar, mix 5 minutes on low speed. Add methylcellulose and mix further until combined. Add bok choy and green onions, mix until combined. Put small amount in wrapper, fold into half moon, seal with water, and cook. Cook by pan-frying in saute pan with canola oil on medium heat until bottoms are browned, then add 1 tablespoon water, place lid on top, and steam until cooked to 165 F internal temperature and then cooked lid off until excess water removed. Components are shown in Table 9. Nutritional information is shown in Table 10.

TABLE 9

| Material | gram |
|---|---|
| Protein food product according to Example 7 | 453 |
| Bok choy, boiled, drained | 240.32 |
| Methylcellulose (Wellence Vege Form 183) | 50 |
| Soy sauce, less sodium | 96 |
| Vinegar, rice, 42 grain | 12 |
| Beef flavor-Springarom BF 7004 | 5 |
| Chicken flavor-Springarom CK 7005 | 3 |
| Green onion, fresh, tops and bulb, minced | 92 |
| Gyoza wrapper | 300 |
| Ginger root, fresh, grated | 18 |
| Garlic, fresh, minced | 200 |

TABLE 10
Nutritional information (as-cooked)

| | |
|---|---|
| Serving size (g) | 27 |
| Calories | 40 |
| Total fat (g) | 1 |
| Saturated fat (g) | 0 |
| Sodium (mg) | 115 |
| Carbohydrates (g) | 4 |
| Fiber (g) | 0 |
| Sugar (g) | 0 |
| Added sugar (g) | 0.0 |
| Protein (g) | 4 |

Dumplings cooked according to the directions above was considered highly palatable and tasty, and very similar in taste and texture to dumplings containing meat.

E) Lasagna. Saute onions, carrots, celery and garlic in oil. Add protein food product and stir well. Add seasoning, rosemary, bay leaves and cook for 2-3 minutes. Add wine and cook down. Add tomato sauce and simmer for 10-15 minutes. Prepare vegan ricotta (place 74.97 g drained tofu, 22.39 g hummus, 2.09 g nutritional yeast, 0.43 g salt, and 0.16 g garlic powder into food processor and process until smooth). Heat oven to 375° F. and set water boiling in large pot. Cook lasagna noodles until just softened. Place layer of noodles in pan, top with half the sauce and one half the tofu mixture. Cover with remaining noodles, remainder of the sauce and tofu mixture. Top with vegan shredded “cheese” of choice; bake 30-40 minutes covered with foil; then increase oven temperature to 450° F. and cook until browned, another 15-20 minutes. Components are shown in Table 11. Nutritional information is shown in Table 12.

TABLE 11

| Material | gram |
|---|---|
| Vegan cheese | 635 |
| Lasagna noodles | 16 oz |
| Protein food product according to Example 7 | 227 g |
| Onion, white, chopped | 89 g |
| Celery, fresh, chopped | 70 g |
| Carrots, fresh, chopped | 94 |
| Bay leaf, dried | 0.4 g |
| Rosemary, dried | 0.7 g |
| Black pepper, ground | 0.6 g |
| White wine | 100 g |
| Oil, canola | 55 g |
| Pasta sauce, creamy tomato and roasted garlic | 1,111 g |

TABLE 12
Nutritional information (as-cooked)

| Serving size (g) | 250 g |
|---|---|
| Calories | 280 |
| Total fat (g) | 13 |
| Saturated fat (g) | 3 |
| Sodium (mg) | 560 |
| Carbohydrates (g) | 25 |
| Fiber (g) | 2 |
| Sugar (g) | 5 |
| Added sugar (g) | 0.0 |
| Protein (g) | 16 |

Lasagna cooked according to the directions above was considered highly palatable and tasty, and very similar in taste and texture to lasagna containing meat.

### Example 17. “Whole Meat” Applications

Substrate—Loaf

A mixture of 190 g of pea protein, 30 g of quinoa, and 30 g of short grain brown rice was added to an 18″×5″×4″ polypropylene bag with a 0.2 micron filter patch and hand-mixed to evenly distribute the contents. Next, 325 ml of RO water was added and the combination was mixed thoroughly by hand until the media was as homogenous as possible. The bag was rolled around the media until the media resembled a brick. The bag was secured with thick rubber bands and autoclaved, 121° c., for 2 hours. After the media cooled to <27° C., the bag was placed in a sterile hood. A sterile skewer was used to poke holes into both long sides of the sterile media. The media was then inoculated with 15 ml of blended M. esculenta (prepared as disclosed above in Example 7) on one side and allowed to incubate for 10 minutes. The “loaf” was turned within the bag (maintaining sterile technique), inoculated with 15 ml of blended M. esculenta, and allowed to incubate for 10 minutes before the bag was sealed and placed in a 26° c. incubator for ten days. After ten days of fermentation followed by pasteurization, the “loaf” had a solid consistency (similar to processed meat), had been partially colonized by mycelia (20-30% by appearance of dark mycelial growth) and upon cooking, had texture similar to that of processed meat, with similar “spring” and “cohesiveness,” and had umami and savory flavors.

Substrate—Sheet

A mixture of 95 g of pea protein, 15 g of quinoa, and 15 g of short grain brown rice were added to an 18″×5″×4″ polypropylene bag with a 0.2 micron filter patch and mixed to evenly distribute the contents. Then, 163 ml of RO water was added and mixed thoroughly until the media was as homogenous as possible. The media was flattened to a thickness of ˜⅛″, the bag sealed, and autoclaved 121° C., for 2 hours. After the media cooled to <27° c., the sterilized media was placed in a sterile hood. The bag was opened and inoculated with 4 ml of media on each long side with blended M. esculenta. The bag was then sealed and placed in a 26° c. incubator for ten days, then pasteurized. The sheet was cut into strips that mimicked bacon in shape and appearance had a solid consistency (similar to processed meat), had been partially colonized by mycelia (20-30% by appearance of dark mycelial growth) had upon cooking, had texture similar to that of processed meat, with similar “spring” and “cohesiveness,” and had umami and savory flavors.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting or” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method to prepare a protein food product for human or animal consumption, comprising the steps of:
(a) providing a sterilized substrate comprising a grain and a plant protein concentrate or isolate, wherein the substrate is at least 50% protein isolate or concentrate by dry weight;
(b) inoculating the sterilized substrate with a filamentous fungal culture in solid state fermentation conditions;
(c) culturing the filamentous fungal culture and the sterilized substrate, wherein the filamentous fungal culture grows hyphae and forms a mycelial network to form the protein food product;
wherein the protein food product, after cooking, is (i) more cohesive than a non-myceliated control substrate after cooking, and/or (ii) has more spring than a non-myceliated control substrate after cooking, and/or (iii) has more juiciness than a non-myceliated control substrate after cooking;
and wherein the protein food product has increased desirable flavors and/or reduced undesirable aromas compared to a non-myceliated control substrate.

2. The method of claim 1, further comprising treating the protein food product to inactivate the filamentous fungus.

3. The method of claim 1, wherein the sterilized substrate has an added water content of at least about 1.5 ml per g of dry weight substrate.

4. The method of claim 1, wherein the filamentous fungal culture is selected from the group consisting of Morchella spp., Lentinula spp., Pleurotus spp and any combination thereof.

5. The method of claim 4, wherein the Morchella spp. is Morchella esculenta, the Pleurotus spp. is Pleurotus ostreatus, Pleurotus salmoneostramineus (Pleurotus djamor), Pleurotus eryngii, or Pleurotus citrinopileatus, and the Lentinula spp. is Lentinula edodes.

6. The method of claim 1, wherein the filamentous fungal culture comprises or consists of Morchella esculenta.

7. The method of claim 1, wherein the plant protein concentrate or isolate comprises pea protein concentrate and wherein the grain is rice, quinoa, chickpea or combinations thereof.

8. The method of claim 7, wherein the increased desirable flavor is an umami flavor and the reduced undesirable aroma is a pea aroma.

9. The method of claim 1, wherein the sterilized substrate comprises 70 to 80% protein concentrate or isolate by dry weight and about 20 to 30% grain by dry weight.

10. The method of claim 1, wherein the culturing step further comprises mixing or tumbling the inoculated substrate periodically throughout the culturing step.

11. The method of claim 1, wherein the grain comprises or is selected from the group consisting of wheat, rye, brown rice, white rice, red rice, gold rice, wild rice, barley, triticale, short grain rice, long grain rice, sorghum, corn, oats, millets, quinoa, buckwheat, fonio, amaranth, teff or durum, barley, brown rice, buckwheat, bulgur (cracked wheat), flaxseed, grano, millet, oats, oat bread, oat cereal, oatmeal, popcorn, whole wheat cereal flakes, muesli, rolled oats, rye, sorghum, spelt, triticale, whole grain barley, wheat berries, whole grain cornmeal, whole rye, whole wheat bread, whole wheat couscous, chickpea, and/or combinations thereof.

12. The method of claim 1, wherein the plant protein concentrate or isolate comprises pea protein concentrate, the filamentous fungus comprises Morchella esculenta, and wherein the grain is rice, quinoa, chickpea or combinations thereof.

13. The method of claim 1, further comprising forming the sterilized substrate into a predetermined shape, wherein the resultant myceliated substrate or retains the predetermined shape.

14. A protein food product made by the method according to claim 1.

15. A protein food product comprising a myceliated substrate for human or animal consumption, wherein the composition comprises a grain and a plant protein concentrate or isolate, wherein the substrate is at least 50% protein isolate or concentrate by dry weight, and a filamentous fungus, wherein the composition exhibits hyphae and a mycelial network in the composition, wherein the protein food product, after cooking, is (i) more cohesive than a non-myceliated control substrate after cooking, and/or (ii) has more spring than a non-myceliated control substrate after cooking, and/or (iii) has more juiciness than a non-myceliated control substrate after cooking; and wherein the protein food product has increased desirable flavors and/or reduced undesirable aromas compared to a non-myceliated control substrate.

16. The protein food product of claim 15, wherein the filamentous fungal culture comprises or is selected from the group consisting of Morchella spp., Lentinula spp., Pleurotus spp. and any combination thereof.

17. The protein food product of claim 16, wherein the Morchella spp. comprises Morchella esculenta, the Pleurotus spp. comprises Pleurotus ostreatus, Pleurotus salmoneostramineus (Pleurotus djamor), Pleurotus eryngii, or Pleurotus citrinopileatus, and the Lentinula spp. comprises Lentinula edodes.

18. The protein food product of claim 15, wherein the filamentous fungal culture comprises or consists of Morchella esculenta.

19. The protein food product of claim 15, wherein the plant protein concentrate or isolate comprises pea protein concentrate and wherein the grain is rice, quinoa, chickpea or combinations thereof.

20. The protein food product of claim 15, wherein the increased desirable flavor is an umami flavor and the reduced undesirable aroma is a pea aroma.

21. The protein food product of claim 15, wherein the grain is selected from the group consisting of wheat, rye, brown rice, white rice, red rice, gold rice, wild rice, barley, triticale, short grain rice, long grain rice, sorghum, corn, oats, millets, quinoa, buckwheat, fonio, amaranth, teff or durum, barley, brown rice, buckwheat, bulgur (cracked wheat), flaxseed, grano, millet, oats, oat bread, oat cereal, oatmeal, popcorn, whole wheat cereal flakes, muesli, rolled oats, rye, sorghum, spelt, triticale, whole grain barley, wheat berries, whole grain cornmeal, whole rye, whole wheat bread, whole wheat couscous, chickpea, and/or combinations thereof.

22. The protein food product of claim 15, wherein the protein food product has a predetermined shape.

23. A food product comprising the protein food product of claim 14.

24. The food product of claim 23, wherein the food product is a meat analog.
